(19) United States
(12) Patent Application Publication
(10) Pub. No.: US 2004/0109927 A1
(43) Pub. Date: Jun. 10, 2004

(54) Carbonate-based anti-caking agent with reduced gas release properties

(76) Inventors: Jit Fu Ang, East Amherst, NY (US); John Francis Pond, Clarence, NY (US); Minghua Wang, Kenmore, NY (US); Lawrence Allan McKee, Williamsville, NY (US)

Correspondence Address: HODGSON RUSS LLP, ONE M & T PLAZA, SUITE 2000, BUFFALO, NY, 14203-2391, US

(21) Appl. No.: 10/723,784

(22) Filed: Nov. 26, 2003

Related U.S. Application Data
(60) Provisional application No. 60/429,607, filed on Nov. 27, 2002.

(51) Int. Cl. A23C 19/00

(52) U.S. Cl. 426/582

(57) ABSTRACT

The present invention provides carbonate-based anti-caking agents with reduced gassing properties and methods for preparing these anti-caking agents. The carbonate-based core material is encapsulated with encapsulating agents, which possess properties that can decrease the contact between the carbonate-based core material and its outer environment to minimize the production of carbon dioxide in the headspace of food package.

### CROSS-REFERENCE TO RELATED APPLICATION

Applicants hereby claim priority based on U.S. Provisional Patent Application No. 60/429,607 filed on Nov. 27, 2002, entitled “Carbonate-Based Anti-Caking Agent With Reduced Gassing Properties.”

### BACKGROUND OF THE INVENTION

Due to their ability to reduce the adherence of individual particles and to enhance the flow characteristics of food products, calcium carbonate and other metal carbonates, as well as blends of metal carbonates, are widely used as anti-caking agents in the food industry. They have been used in powdered products, such as milk powder, soft drinks (powdered), soups and sauces (powdered), instant baking mixes, etc., shredded products, cubed, diced, and many other forms of cut-up foods to improve the flow properties of these products. In order to enhance the anti-caking function of carbonate-based anti-caking agents, they are often blended with other anti-caking ingredients (such as cellulose). Although the applications of calcium carbonate and other carbonate-based anti-caking agents are acceptable in foods that are relatively dry (moisture content less than 5-10%), a severe problem is encountered when they are applied to foods that contain relatively high moisture (higher than 30%), such as cheese. In addition, foods that have a pH lower than neutral 7 pose a severe challenge to the application of carbonates because carbonates are relatively unstable in an acidic environment. Even though most metal carbonates are stable under alkaline conditions because they are insoluble, the metal carbonates can dissociate into metal ions and carbonic acid under acidic conditions. This dissociation increases as the acidity of the solution increases. For example, at pH 8, the molar solubility of calcium carbonate is 0.0011. The molar solubilities of calcium carbonate increase to 0.02 and 1.7 when pH is decreased to 6 and 4, respectively. Therefore, when exposed to acids or acidic environments, a large amount of the metal carbonate can dissociate into carbonic acid, and in turn, the carbonic acid can be converted to carbon dioxide. Even though some of this carbon dioxide can dissolve in the water contained within the food, excess production of carbon dioxide in a package, especially at the beginning of storage, can result in a significant increase in the volume of the headspace within a food package. This can cause severe bulging and uneven packages. Therefore, there is a need to minimize or control and delay the release of carbon dioxide into the headspace of a package when metal carbonate is used in foods that are relatively moist.

This invention overcomes the above problem by encapsulating the metal carbonate with a coating material, preferably a hydrophobic coating material. It is expected that the desired hydrophobic coating is stable under moist environments and provides a barrier to prevent the diffusion or penetration of the external liquid medium as well as the migration of the metal carbonate across the coating to the external environment.

Encapsulation is a micro-package technique that involves coating small liquid droplets or solid particles with films of another material. The material that is coated or entrapped is called core material, active, filler or internal phase. The material that forms the film is called wall material, carrier, membrane, shell or coating material. Encapsulation is to protect the core material from the environment that can be destructive to the core material, such as light, oxygen, moisture; to separate the reactive components within a mixture; and to provide controlled or delayed release. In the food industry, ingredients that have commonly been encapsulated include flavors, fats and oils, vitamins, minerals, acidulants, colorants, enzymes, and microorganisms. Wall materials that are commonly used in food applications include natural and modified-carbohydrates, cellulose, gums, lipids, proteins, and inorganic materials. These encapsulated food ingredients are used in a variety of food systems such as cheese, meat products, bakery mixes, seasoning blends, beverage mixes, and nutritional food systems.

To accomplish the intended purpose of encapsulation, a capsule is designed so that its coating protects the core material, and later releases the core material into the food system during food processing or storage. In general, the release of the core material from the capsules can be obtained by changing temperature, moisture, pH and osmotic pressure of the environment. In some cases, due to the core migration from the coating material, the coated material can also be released. For polysaccharide/hydrocolloid-coated capsules, exposing the capsules to moisture environment to break down the coatings can release the core material. For lipids-coated material, heat can be used to dissolve lipid-based coating and release the encapsulated ingredient into the food system. For example, in a lipid-coated leavening agent, the active ingredients are released during baking. In the present application, when lipids are used as a coating material, the core material will be expected not to release or to release at a controlled rate during the subsequent processing.

Several encapsulation methods can be used to prepare capsules. When lipids are used as coating materials, for application at small scale, a regular blender equipped with an atomizer can be used. When the melting points of lipids are low, such as liquid oil at room temperature, the liquid oil can be directly atomized onto the calcium carbonate as the blender is running. A homogenous mixture can be obtained as blending continues. When the lipids are solids at room temperature, the calcium carbonate and lipids are heated up to several degrees (5 to 20° C.) above the melting points of the lipids. Then the heated calcium carbonate and lipids are loaded into the blender to produce a homogeneous distribution with continuous blending. After continuously blending for a few minutes, as the temperature of the lipids and calcium carbonate gradually decreases, the lipids gradually solidify and deposit on the surface of the solid particles. When the lipid content is higher than 20%, the coated particles may form agglomerates, continuously blending may destroy and break up the large particles. Another technique would involve heating the calcium carbonate and lipids in a melting tank and agitating them to produce homogeneous dispersion. The temperature of the melting tank is kept sufficiently high to maintain the lipids in a fluid state. The mixture is pumped with pressure and the mixtures are atomized into droplets. Then the droplets are quickly chilled by blowing cool air into the tower. When the droplets travel through the cool air in the tower, the lipids further solidify around the metal particles, and the coated droplets fall to the bottom of the chamber to be collected and screened. This is known as spray chilling. Some other techniques such as fluid bed techniques and modified fluid bed techniques can also be used. In the fluid-bed techniques, the lipids are melted, and the calcium carbonate is loaded into a fluidized bed reactor. The air flows passing through the reactor and the flow rate of the air is adjusted so that the particles are slightly levitated, then the liquidized oil is sprayed over the calcium carbonate to encapsulate the calcium carbonate in the fluidized bed reactor. Then the fluidized air levitating the calcium carbonate is cooled and causes the fat to solidify and encapsulate the ingredient.

Therefore, what is needed is a microencapsulation technique to encapsulate metal carbonates with a hydrophobic layer, which provides a barrier and prevents the contact of the metal carbonate with external environment.

### SUMMARY OF THE INVENTION

The present invention provides carbonated-based metal anti-caking agents with reduced gassing properties and provides methods for preparing these anti-caking agents. The anti-caking agents are metal carbonates and coated with lipid layers which provide a barrier to prevent the diffusion or penetration of external medium into the coated core material. The methods include processes of preparing the capsules containing the carbonate-based metal. This coated metal carbonate anti-caking agent can be combined with other traditional anti-caking agents to enhance its anti-caking function. Preferably, these anti-caking blends can be used in relatively high moisture and/or acidic environments, such as shredded, diced, cubed cheese and other similar foods and non-food systems.

The major ingredient components of this invention include the core material (carbonate-based metal anti-caking agents and blends of it), and the coating material. Preferably, at room temperature, the coating layer is sufficiently impermeable to the outside environment and can prevent migration of water. The coating ingredient may be selected from but is not limited to the following examples: lecithin, oil soluble colors, mineral and vegetable oils, fats, hydrogenated vegetable oils, and other vegetable, animal, and organic sources of fats and waxes. Preferably, the coating is lecithin and hydrogenated vegetable oils and combination of lecithin or other emulsifiers with above lipids. When the lipids are liquid at room temperature, the coating should comprise about 0.01-50%, by weight, of the total ingredients. Preferably, the coating should comprise about 1-20%, by weight, of the total ingredients. When the lipids are solid at room temperature, the coating should comprise at least 0.1% to 75%, by weight, of the total ingredients. Preferably, the coating should comprise about 1% to 50%, by weight, of the total ingredients, and most preferably about 20-50% by weight of the ingredient.

The anti-caking agents can be any metal carbonates such as but not limited to calcium carbonate, sodium carbonate, magnesium carbonate and potassium carbonate; alkaline earth metal carbonate; ammonium carbonate; as well as bicarbonates, such as sodium bicarbonate and ammonium bicarbonate. The metal carbonates should have a mean particle size from 0.2 to 100 microns and up. Preferably the mean particle size is from 5 to 100 microns.

The lipid-coated metal carbonates can be blended with other anti-caking agents, such as but not limited to cellulose, microcrystalline cellulose, starch, flour, and other minerals. They can also be blended with other materials such as but not limited to preservatives, anti-microbial ingredients, anti-mycotic agents, color, flavor, fortification material, and enzymes.

The present invention provides carbonate-based metal anti-caking agents with reduced gassing properties. And the present invention is directed to the preparation of a carbonate-containing anti-caking agent with delayed and controlled or eliminated release of carbon dioxide. Furthermore, the controlled release of carbon dioxide can also provide an extra advantage which allows release of carbon dioxide under desired conditions.

### DETAILED DESCRIPTION

The present invention provides metal carbonate-based anti-caking agents with reduced gassing properties and a process for preparing the metal carbonate-based anti-caking blends. The ingredients of the anti-caking agent include metal carbonate(s), and an encapsulating agent. The method of preparing this anti-caking agent includes encapsulating the metal carbonates with the encapsulating-agent, which provides an efficient barrier to prevent the contact of the carbonate-based salt with the outside environment. This coated metal carbonate anti-caking agent can be combined with other conventional anti-caking agents to enhance its anti-caking function.

In this invention, the carbonate-based core material may be any metal carbonate, especially those approved for use in the food industry. These metal carbonates will include but are not limited to alkali-metal carbonates, such as sodium carbonate and potassium carbonate; alkaline earth metal carbonates, such as calcium carbonate and magnesium carbonate; ammonium carbonate, as well as bicarbonates, such as sodium bicarbonate and ammonium bicarbonate.

The particle size of the carbonated-based salt is important in this invention, particularly if the invention will be used in foods. Small particles have large surface area/volume ratios and this will increase the contact of the carbonate-based salt with the outside environment, resulting in higher production of carbon dioxide. The present invention prefers the use of larger particle sized carbonates. The carbonates used in this invention have a mean particle size from about 5 to 20 microns, preferably from about 10 to 20 microns. However, this invention will work with carbonates of all particle sizes.

The coating material should possess hydrophobic properties and protect the core material from contact with the outside environment. Any hydrophobic material, or mixture thereof, which is capable of coating or encapsulating, at least a portion of particles of the carbonate salt can be used in this invention. The coating materials can be selected from but are not limited to the following group of materials: oils, including lecithin, oil soluble colors, mineral oils, and vegetable oils such as soy oil, peanut oil, corn oil, canola, cottonseed oil and sunflower seed oil, fats, hydrogenated vegetable oils, and other vegetable, animal or organically derived fats and waxes. Preferred hydrogenated vegetable oils include hydrogenated cottonseed, corn, peanut, soybean, palm, palm kernel, sunflower and safflower oils. Other ingredients which can be incorporated in the hydrophobic coating include bees wax, petroleum wax, paraffin wax, rice bran wax and castor wax.

The encapsulating agent may be present at 0.01% to 75% of the composition by weight. When encapsulating agents are liquid at room temperature, preferably, the encapsulating agent is present in the composition from about 0.01% to 50%, most preferably from 1% to 20% of the composition by weight. When the encapsulating agents are solids at room temperature, preferably, the encapsulation agent is present in the composition from about 0.1% to 75%, and more preferably from 20% to 50%.

The carbonate-based anti-caking agents with reduced gassing properties can be prepared by the following methods but are not limited to them: spray-chilling, fluid bed, and modified fluid bed techniques. In the present invention for small scale production, the particles are prepared with a blender equipped with an atomizer. When the coating materials are liquid at room temperature, it can be directly atomized onto the solid particle with the blender running. When the coating materials are solids at room temperature, they can be heated up together with the core material to temperatures above their melting points. Then the heated compounds are immediately loaded into the blender (at room temperature) with continuously blending to produce homogeneous distribution. After continuously blending for 3-5 min, with the gradual decrease in the temperature, the coating materials can solidify and deposit on the surface of the carbonates. When the coating material content is more than 20%, large aggregates may be formed during processing. It may be desirable to break these large particles and screen them before using.

Depending on the application, the capsules can be designed so that no release or minimal release of carbon dioxide from carbonate-based metal occurs during the storage. In this case, the core particle is completely encapsulated within coating material and cannot migrate across the coating material. In addition, the coating layers are expected to be sufficiently thick and sufficiently continuous. They are not permeable to outside medium and can provide adequate time to delay the release of carbon dioxide from the metal carbonate. It is also important that minimal amounts of cracks, channels or pores in the wall, which connect the core to the outside environment, are present. Capsules formed using a high level of high melting point lipids to coat the metal carbonate belonging to this group.

In other applications, the capsules can be designed to release carbon dioxide at controlled rates. For this kind of capsules, changing the wall composition and thickness can result in different release rates of carbon dioxide from the core material. Using lipids with different melting points or materials with different hydrophobic and hydrophilic balance can adjust the release rate of core material. Lipids with different melting points and melting ranges have different proportion of liquid and solids status at room temperature, resulting in different permeability of coating layer to outside medium. Materials with different hydrophobic and hydrophilic balance have different water association ability, causing different interaction between the coating material and outside aqueous environment. As a result, the release rate of core material can be manipulated. Changing the wall thickness can change the water molecule diffusion path across the coating and in turn will cause a different release rate of carbon dioxide from the core material.

The coated metal carbonate can be blended with other materials including other anti-caking agents or can be used alone. It can be combined with other anti-caking agents such as but not limited to cellulose, microcrystalline cellulose, potato starch, corn starch, rice flour, calcium silicate, calcium stearate, calcium phosphate, calcium sulfate, silicon dioxide, sodium silico-aluminate and other anti-caking agents. It can also be combined with chemical, natural, and synthetic preservatives, such as potassium sorbate, sorbic acid, cultures; anti-mycotic material such as natamycin; and enzymes to work together as functional anti-caking agents. When the coated metal carbonate is blended with other ingredients, the coated metal carbonate may be present from 1% to 100% of the composition in the blends by weight.

One of the applications for the material of this invention is in food products which need to prevent caking and improve flowability. For example, the food product can be a divided cheese material, or any other foods that might be subjected to caking. The divided cheese material may be any type of cheese. The cheese may be divided in any manner known to divide cheese.

The coated metal carbonate together with other ingredients included in the anti-caking blends is present in the food material composition in an amount effective to provide anti-caking function to the food material composition. Preferably the anti-caking ingredient is present in the food material composition from about 0.1% to about 50% of the food composition by weight, and more preferably from about 0.5% to about 6% of the food composition by weight.

Generally, the production of carbon dioxide in the sealed package after storage is used to monitor and to evaluate the encapsulation efficiency. The following examples will illustrate our present invention. They are for illustrative purpose only and are not meant to limit the claimed invention in any manner.

In all of the following examples, block part skim Mozzarella cheese was shredded and used as the model food material since this food product has a relatively high moisture content (45% to 55%) and is slightly acidic in pH (5.2-5.7). Calcium carbonate coated with different lipids and blends of coated calcium carbonate with powdered cellulose were added to the shredded cheese at a 2% level (percentage was based on the weight of the finished cheese product) and were distributed evenly on the cheese. Then 200 g of cheese added with anti-caking agent were put into a gas impermeable bag and 200 ml of room air was injected into the bag, and then the bag was sealed. The bags were stored at refrigerated temperature (4° C.) and carbon dioxide content in the bags was tested periodically by a gas analyzer.

The cheese samples were purchased from a local supermarket and different batches of cheese with slightly different moisture content and pH were used. Therefore, same calcium carbonate sample may produce different amount of carbon dioxide in the headspace of the package from these different batches of cheese. In addition, some starter cultures which are added during the cheese making will also produce some carbon dioxide in the headspace of the cheese package. Therefore, the detected carbon dioxide in the cheese package includes both these sources. In order to compare the encapsulation efficiency and differentiate the source of carbon dioxide, one batch of cheese was used in each set of experiment. The Control cheese sample was prepared by addition of 2% pure powdered cellulose, an anti-caking agent that does not produce carbon dioxide. The carbon dioxide detected in this control sample is mainly due to the metabolism product from starter culture included in the cheese itself.

### EXAMPLE 1

Effect of Calcium Carbonate Particle Size on the Release of Carbon Dioxide

Carbon Dioxide Content (v/v %) in the Headspace of Cheese Package

| | |
|---|---|
| Average particle | Days in refrigerated storage |

| size (microns) | 0 | 6 | 10 | 15 |
|---|---|---|---|---|
| 5.5 | 0 | 5.9 | 11.8 | 19 |
| 6 | 0 | 3.3 | 4.4 | 10.7 |
| 12 | 0 | 3.1 | 3.5 | 6.9 |
| 17 | 0 | 3.2 | 3.7 | 4 |
| 20 | 0 | 2 | 2.1 | 3.6 |

In Example 1, effect of the particle size of calcium carbonate on the release rate of carbon dioxide in the cheese package was compared. All the tested calcium carbonates were pure uncoated calcium carbonates. As demonstrated by the data above, particle size of calcium carbonate significantly affected the production of carbon dioxide released into the package. Small particles resulted in higher production of carbon dioxide in the cheese package during the storage. When the particle size of the calcium carbonate decreased from 20 microns to 5.5 microns, more than five times the carbon dioxide was produced in the headspace of the cheese package after 15 days of storage. Therefore, calcium carbonate with a larger particle size is preferred in this invention. Most applications today use calcium carbonates that have an average particle size of less than 15 microns. In order to further decrease the release of carbon dioxide from the calcium carbonate, larger particle size calcium carbonate (20 microns) was coated with different coatings. Examples 2 to 4 illustrate the effect of different coating materials to reduce the release of carbon dioxide from calcium carbonate.

### EXAMPLE 2

Efficacy of the Ingredient

Carbon Dioxide Content (v/v %) in the Cheese Package

Days in refrigerated storage

| Lecithin (%) | 0 | 7 | 9 | 14 |
|---|---|---|---|---|
| 1 | 0 | 1.6 | 1.9 | 2.4 |
| 2 | 0 | 1.3 | 1.7 | 2.4 |
| 3 | 0 | 1 | 1.3 | 2.3 |
| 4 | 0 | 1 | 1.1 | 2 |
| 5 | 0 | 0.8 | 1 | 1.3 |
| Control 1 | 0 | 2.4 | 4.1 | 7 |
| Control 2 | 0 | 0.3 | 0.4 | 0.5 |

In this example, calcium carbonate (20 microns) was coated with 1% to 5% soy lecithin (weight percent based on the encapsulated calcium carbonate). Cheese samples were prepared as described above. Control 1 was a cheese sample added with 2% pure uncoated calcium carbonate with a particle size of 20 microns and Control 2 was a cheese sample added with 2% pure powdered cellulose. The encapsulation process for the calcium carbonate coated with lecithin was as follows:

Load the calcium carbonate into a blender.

Run the blender.

Separately, prepare the lecithin by heating (if necessary) to reduce its viscosity for easier atomization and spraying.

Atomize the required designed amount of lecithin onto the calcium carbonate with the blender running.

Continue blending until a homogeneous mixture is obtained.

As demonstrated in example 2, encapsulating the calcium carbonate with soy lecithin significantly reduced the release of carbon dioxide into the headspace of the cheese package during refrigerated storage. When the encapsulating agent was increased from 1% to 5%, the carbon dioxide production in the headspace of the cheese package decreased from 2.4% to 1.3% after 14 days of storage. In contrast, the Control 1 sample (uncoated calcium carbonate) produced about 7% carbon dioxide during the same storage time. The results indicated that encapsulating calcium carbonate with a higher amount (5%) of encapsulating agent significantly decreased the release of carbon dioxide from calcium carbonate. Example 2 also shows that the release rate of carbon dioxide into the cheese package can be adjusted by using different levels of encapsulating agent.

### EXAMPLE 3

Carbon Dioxide Content (v/v %) in the Cheese Package

Days in refrigerated storage

| Mineral oil (%) | 6 | 10 |
|---|---|---|
| 2.5 | 1.9 | 2.4 |
| 5 | 1.8 | 2.3 |
| Control 1 | 2.6 | 7.9 |
| Control 2 | 0.3 | 0.5 |

In this example, calcium carbonate (20 microns) was coated with 2.5% and 5% mineral oil (weight percent based on the encapsulated calcium carbonate). Cheese samples were prepared in the same way as described above. Control 1 was a cheese sample added with 2% pure uncoated calcium carbonate (particle sizes 20 microns) and Control 2 was a cheese sample added with 2% powdered cellulose. The encapsulation process for the coated calcium carbonate was the same as described in example 2. In this example, calcium carbonate coated with mineral oil demonstrated a slow release of carbon dioxide in the cheese package. However, this rate of carbon dioxide release was significantly lower than that in uncoated calcium carbonate.

### EXAMPLE 4

Carbon Dioxide Content (v/v %) in the Cheese Package

Days in refrigerated storage

| Stearines (%) | 5 | 10 | 15 |
|---|---|---|---|
| 5 | 1.1 | 1.4 | 2 |
| 10 | 0.4 | 0.7 | 1.1 |
| 20 | 0.2 | 0.4 | 0.7 |
| Control 1 | 1.5 | 2.1 | 4.2 |
| Control 2 | 0.1 | 0.6 | 0.8 |

In this example, the calcium carbonate (20 microns) was coated with 5%, 10% and 20% of stearines, partially hydrogenated soybean and cottonseed oils (melting point of 125° F.). Control 1 was a cheese sample added with 2% pure uncoated calcium carbonate (20 microns), while Control 2 was a cheese sample added with 2% powdered cellulose. The encapsulating process was performed using the following procedures:

Heat calcium carbonate and stearines in an oven at 300° F. for 5-10 min or until the lipid is completely melted.

Then load the heated calcium carbonate and lipids into a blender at room temperature and blend at high speed for 2-5 min.

Continue blending at middle speed, while the temperature of the lipids decreases. The lipids solidify and deposit on the surface of the calcium carbonate.

When the lipid content is higher then 10%, after blending at high speed, the mixture of calcium carbonate and lipids may initially develop into a soft paste. Let this cool down to form a semi-dry paste. Then blend at middle or high speed to break the agglomerates into small granules and individual particles. The encapsulated products may be screened by passing through different mesh screens to select desired particle size.

Results of carbon dioxide production in the headspace of the cheese package indicated that encapsulating calcium carbonate with the partially hydrogenated vegetable oils can significantly reduce the release of carbon dioxide. When using 20% lipids to coat calcium carbonate, the release of carbon dioxide from calcium carbonate can be completely stopped. In this sample, after 15 days of storage at refrigerated temperature, only about 0.7% of carbon dioxide was detected in the headspace of cheese package. This amount of carbon dioxide was mainly due to the metabolism from starter cultures which were added during the cheese making process. A similar amount of carbon dioxide was also detected in the cheese sample added with only powdered cellulose.

### EXAMPLE 5

In Examples 5 and 6, small particle-sized calcium carbonate (5.5 microns) were also encapsulated with soy lecithin (Example 5) and Stearines (Example 6) to test the encapsulation efficiency.

Carbon Dioxide Content (v/v %) in the Cheese Package

Days in refrigerated storage

| Lecithin (%) | 5 | 10 | 15 |
|---|---|---|---|
| 2.5 | 4.5 | 5 | 4.9 |
| 5 | 4.6 | 4.9 | 4.9 |
| 7.5 | 3.7 | 4 | 4.6 |
| Control 1 | 5 | 5.6 | 7.7 |
| Control 2 | 0.1 | 0.6 | 0.7 |

In Example 5, the calcium carbonate (5.5 microns) was coated with 2.5%, 5%, and 7.5% soy lecithin (weight percent based on the capsules). Control 1 was pure uncoated calcium carbonate (particle sizes 5.5 microns) while Control 2 was cheese sample added with 2% powdered cellulose. The encapsulation process was the same as that described in Example 2.

This example indicated that although the overall carbon dioxide production from coated calcium carbonate of small particle size was higher than those from coated calcium carbonate of large particle sizes (Example 2), production of carbon dioxide was significantly lower than those of uncoated small particle size calcium carbonate.

### EXAMPLE 6

Carbon Dioxide Content (v/v %) in the Headspace of Cheese Package

Days in refrigerated storage

| Stearines (%) | 5 | 10 | 15 |
|---|---|---|---|
| 5 | 4.1 | 4.8 | 5.2 |
| 10 | 2.6 | 3.4 | 3.8 |
| 20 | 0.6 | 0.9 | 1.1 |
| Control 1 | 5 | 5.6 | 7.7 |
| Control 2 | 0.1 | 0.6 | 1.0 |

In this example, the small particle size of calcium carbonate (5.5 microns) was coated with 5%, 10% and 20% stearines. Control 1 was cheese sample added with 2% pure uncoated calcium carbonate (5.5 microns), while Control 2 was cheese sample added with 2% powdered cellulose. The encapsulating process was the same as those described in Example 4.

Results of carbon dioxide production in the headspace of the cheese package were very similar to those of Example 4. Encapsulating small particle calcium carbonate with stearines at 20% stopped the production of carbon dioxide.

### EXAMPLE 7

In order to enhance the anti-caking function of calcium carbonate, in Examples 7 and 8, coated calcium carbonate was blended with powdered cellulose at ratio of 50:50. These blends were then added into shredded cheese.

Carbon Dioxide Content (v/v %) in the Headspace of Cheese Package

Days in refrigerated storage

| Lecithin (%) | 5 | 10 | 15 |
|---|---|---|---|
| 2.5 | 0.9 | 1.2 | 3.3 |
| 5 | 0.7 | 1.1 | 2.3 |
| 7.5 | 0.6 | 0.8 | 1.1 |
| Control 1 | 1.3 | 2.5 | 5.1 |
| Control 2 | 0.2 | 0.4 | 1.1 |

In Example 7, calcium carbonate (20 microns) was first coated with soy lecithin. Then the coated calcium carbonate was blended with powdered cellulose at a 1:1 ratio. Control 1 was cheese added with 2% anti-caking agent consisting of 50% pure uncoated calcium carbonate (20 microns) and 50% powdered cellulose. Control 2 was cheese sample added with 2% powdered cellulose. The results indicated that coating calcium carbonate with lecithin and then blending with a powdered cellulose also resulted in delayed release of carbon dioxide in the cheese package.

### EXAMPLE 8

Carbon Dioxide Content (v/v %) in the Headspace of Cheese Package

Days in refrigerated storage

| Stearines (%) | 5 | 10 | 15 |
|---|---|---|---|
| 5 | 0.6 | 1.4 | 2.1 |
| 10 | 0.4 | 0.7 | 1.2 |
| 20 | 0.2 | 0.3 | 0.6 |
| Control 1 | 1.3 | 2.5 | 5.1 |
| Control 2 | 0.2 | 0.4 | 1.1 |

In Example 8, the calcium carbonate (20 microns) was coated with 5%, 10% and 20% stearines. The coated calcium carbonate was then blended with powdered cellulose at a 1:1 ratio. Control 1 was a cheese sample added with 2% anti-caking agent containing 50% pure uncoated calcium carbonate (20 microns) and 50% powdered cellulose. Control 2 was a cheese sample added with 2% powdered cellulose as anti-caking agent. Similar to Example 7, in all cases, coating calcium carbonate with stearines and blending with powdered cellulose significantly reduced carbon dioxide production in the cheese package compared with those of blends in which calcium carbonate was not coated.

It is to be understood that the foregoing are merely embodiments of the invention and that various changes and alterations can be made without departing from the spirit and broader aspects thereof as set forth in the appended claims, which are to be interpreted in accordance with the principles of patent law including the Doctrine of Equivalents.

What is claimed:

1. A food composition comprising:
a perishable solid food material; and,
an anti-caking composition dispersed in or on the perishable food material, the anti-caking composition having a carbonate-based core material encapsulated by a hydrophobic material.

2. The food composition of claim 1, wherein the carbonate-based core material comprises calcium carbonate, sodium carbonate, magnesium carbonate, potassium carbonate, alkaline earth metal carbonate, ammonium carbonate, sodium bicarbonate, ammonium bicarbonate or combinations thereof.

3. The food composition of claim 1, wherein the hydrophobic material comprises lecithin, oil soluble colors, mineral oil, vegetable oil, hydrogenated vegetable oil, wax or animal fat.

4. The food composition of claim 1, wherein the anti-caking composition is provided in an amount of from about 0.5% to 6% by weight of the food composition.

5. The food composition of claim 1, wherein the food material has a moisture content greater than 30%.

6. The food composition of claim 1, wherein the food material has a pH lower than 7.0.

7. The food composition of claim 1, wherein the carbonate-based core material has a mean particle size of about 20 micron.

8. The food composition of claim 1, wherein the hydrophobic material is provided in an amount of from about 1-20% by weight of the anti-caking composition.

9. The food composition of claim 1, wherein the hydrophobic material is provided in an amount of from about 20-50% by weight of the anti-caking composition.

10. The food composition of claim 1, wherein the anti-caking composition is combined with an anti-caking material in a ratio of about 1:1.

11. The food composition of claim 1, wherein the food material is cheese.

12. A food composition comprising:
a perishable solid food material having a moisture content of at least 30% and having a pH less than 7; and,
an anti-caking composition dispersed in or on the perishable food material, the anti-caking composition having a carbonate-based core material encapsulated by a hydrophobic material.

13. An anti-caking composition, comprising:
a carbonate-based core material; and,
a hydrophobic material encapsulating the core material.

14. The anti-caking composition of claim 13, wherein the carbonate-based core material has a mean particle size of about 10-20 microns.

15. The anti-caking composition of claim 13, wherein the hydrophobic material is provided in an amount of from about 1-20% by weight of the anti-caking composition.

16. The anti-caking composition of claim 13, wherein the hydrophobic material is provided in an amount of from about 20-50% by weight of the anti-caking composition.

17. The anti-caking composition of claim 13, wherein the anti-caking composition is combined with an anti-caking material in a ratio of about 1:1.

18. A method for making an encapsulated anti-caking agent comprising the steps of:
a. providing a carbonate-based core material;
b. providing a hydrophobic material; and
c. encapsulating the carbonate-based core material with the hydrophobic material to obtain an encapsulated carbonate-based material wherein the rate of carbon dioxide formation from the encapsulated carbonate-based material upon exposure to moisture is less than the rate of carbon dioxide formation from the carbonate-based material before encapsulation, upon exposure to moisture.

19. The method of claim 18, wherein the carbonate-based core material comprises calcium carbonate, sodium carbonate, magnesium carbonate, potassium carbonate, alkaline earth metal carbonate, ammonium carbonate, sodium bicarbonate, ammonium bicarbonate or combinations thereof.

20. The method of claim 18, wherein the carbonate-based core material has a mean particle size greater than 0.2 microns.

21. The method of claim 18 wherein the carbonate-based core material has a mean particle size of 5 to 100 microns.

22. The method of claim 18, wherein the hydrophobic coating material comprises lecithin, oil soluble colors, mineral oil, vegetable oil, hydrogenated vegetable oil, wax or animal fat.

23. The method of claim 18, wherein the hydrophobic coating material comprises about 0.01% to about 50% by weight of anti-caking agent.

24. The method of claim 18, wherein the hydrophobic coating material comprises about 1% to about 20% by weight of anti-caking agent.

25. The method of claim 18, wherein when the hydrophobic coating material is solid at room temperature, the hydrophobic coating material comprises at least 0.1% by weight of the anti-caking agent.

26. The method of claim 18, wherein the hydrophobic coating material is solid at room temperature and the hydrophobic coating material comprises from about 0.5% to about 50% by weight of the anti-caking agent.

27. The method of claim 18, wherein the hydrophobic coating material is solid at room temperature and the hydrophobic coating material comprises at from about 20% to about 50% by weight of the anti-caking agent.

28. The method of claim 18, wherein the carbonate-based core material is encapsulated by the hydrophobic material by atomizing the hydrophobic material onto the carbonate-based core material.

29. The method of claim 18, wherein the carbonate-based core material is encapsulated by the hydrophobic material by spraying the hydrophobic material onto the carbonate-based core material.

30. The method of claim 18, wherein the carbonate-based core material is encapsulated by the hydrophobic material by a fluid bed.

31. The method of claim 18, wherein the carbonate-based core material is encapsulated by the hydrophobic material by heating and blending the hydrophobic material with the carbonate-based core material.

32. The method of claim 18, wherein the carbonate-based core material is encapsulated by the hydrophobic material by spray chilling the hydrophobic material onto the carbonate-based core material.

33. An anti-caking agent comprising a carbonate-based core material having a mean particle size of 5-20 micron, the core material encapsulated with a hydrophobic coating material wherein the rate of carbon dioxide formation from the encapsulated carbonate-based core material is less than the rate of formation of carbon dioxide from the carbonate-based core material without encapsulation by the hydrophobic coating material.

34. The anti-caking agent of claim 33, wherein the carbonate-based core material comprises calcium carbonate, sodium carbonate, magnesium carbonate, potassium carbonate, alkaline earth metal carbonate, ammonium carbonate, sodium bicarbonate, ammonium bicarbonate or combinations thereof.

35. The anti-caking agent of claim 33, wherein the hydrophobic coating material comprises lecithin, oil soluble colors, mineral oil, vegetable oil, hydrogenated vegetable oil, wax or animal fat.

36. The anti-caking agent of claim 33, wherein the hydrophobic coating material comprises about 0.01% to about 50% by weight of anti-caking agent.

37. The anti-caking agent of claim 33, wherein the hydrophobic coating material comprises about 1% to about 20% by weight of anti-caking agent.

38. The anti-caking agent of claim 33, wherein when the hydrophobic coating material is solid at room temperature, the hydrophobic coating material comprises at least 0.5% by weight of the anti-caking agent.

39. The anti-caking agent of claim 33, wherein the hydrophobic coating material is solid at room temperature and the hydrophobic coating material comprises from about 0.1% to about 50% by weight of the anti-caking agent.

40. The anti-caking agent of claim 33, wherein the hydrophobic coating material is solid at room temperature and the hydrophobic coating material comprises at from about 20% to about 50% by weight of the anti-caking agent.

41. The anti-caking agent of claim 33, wherein the carbonate-based core material is encapsulated by the hydrophobic material by atomizing the hydrophobic material onto the carbonate-based core material.

42. The anti-caking agent of claim 33, wherein the carbonate-based core material is encapsulated by the hydrophobic material by spraying the hydrophobic material onto the carbonate-based core material.

43. The anti-caking agent of claim 33, wherein the carbonate-based core material is encapsulated by the hydrophobic material by a fluid bed.

44. The anti-caking agent of claim 33, wherein the carbonate-based core material is encapsulated by the hydrophobic material by heating and blending the hydrophobic material with the carbonate-based core material.

45. The anti-caking agent of claim 33, wherein the carbonate-based core material is encapsulated by the hydrophobic material by spray chilling the hydrophobic material onto the carbonate-based core material.
